(19) United States
(12) Patent Application Publication
(10) Pub. No.: US 2008/0251434 A1
(43) Pub. Date: Oct. 16, 2008

(54) Manually Operable Water Purifying Device

(75) Inventor: Johan Marra, Eindhoven (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 12/088,644

(22) PCT Filed: Sep. 25, 2006
(86) PCT No.: PCT/IB06/53470

§ 371 Date: Mar. 28, 2008

(30) Foreign Application Priority Data
Sep. 28, 2005 (EP) 05108959.7

(51) Int. Cl. C02F 1/00; B01D 33/01; F04B 9/14

(52) U.S. Cl. 210/119; 210/232; 210/117

(57) ABSTRACT

The present invention relates to a manually operable device for purifying water, comprising a water container for receiving and holding an amount of non-purified water, comprising a bottom and side walls and adapted to receive a manually operable piston-type filter assembly, said filter assembly comprising filtering means for filtering said non-purified water, wherein said filter assembly is adapted to be manually forced towards the bottom of the said container, thereby allowing non-purified water to pass through the said filtering means thereby purifying the water. With the device according to the invention a low-cost water purifier is provided which can be used to provide an improved drinking water quality under primitive (outdoor) conditions, wherein no water pressure and/or electricity is present.

The present invention relates to a manually operable water-purifying device, and to a method for purifying water using said device.

Water-purifying devices are known for a considerable period of time and are generally used for purifying water in such a way that the water becomes suitable for human consumption. The improvements in water quality that are pursued generally relate to the aesthetic quality of the water (i.e. color, smell, taste), the removal of solutes and/or particles that are hazardous to human health (such as heavy metals, pesticides, organic compounds, and microorganisms such as bacteria, viruses, cysts etc.) and the removal of turbidity caused by suspended particles such as sand, metal oxides etc.

Well-known water purification techniques include distillation, boiling, chemical disinfection, reverse osmosis, treatment with UV radiation, filtering of water through granular absorption filters or compressed block filters (usually containing activated carbon, ion exchange resins, and/or other adsorption/absorption media) and/or sediment filters or particle filters for removing turbidity. The application of water-purifying devices based on one or more of these water purification techniques is well-developed in the household environment where both water pressure (from a piped water supply or from an electrical pump) and electricity are generally readily available, and a good water quality can normally be attained.

However, in situations where water pressure and electricity are not available, such as in relatively primitive rural areas in many Third World countries, these techniques cannot always be readily used. The high cost of many excellently performing water-purifying devices imposes another serious constraint to their application in Third World countries. An absence of water pressure and electricity can also be encountered while camping and/or hiking etc. in the outdoor environment, or after natural disasters such as earthquakes, floods etc. The availability of fresh clean water is then usually compromised. As the availability of fresh drinking water is critical to life, a need exists to have access to reliable low-cost water purifiers that allow surface water, well water, and/or collected rain water to be made suitable for human consumption under a wide variety of circumstances with only passive, non-electrical means. Here, the most critical requirement is the microbiological safety of the water: pathogenic microorganisms such as bacteria, cysts and viruses should at least be partially and preferably fully removed from the water. As a matter of fact, any incremental improvement in the water quality is to be pursued in order to at least reduce the number of water-borne diseases. Additional needs may exist in certain localities to also remove arsenic and/or fluoride from the water.

Some water-purifying devices or techniques exist that can be used under the primitive conditions described above. These include solar disinfection of water in plastic bottles, chemical flocculation, bio-sand filters, gravity-fed water purifiers and water purifiers equipped with a manual air pump. The latter two types of water purifiers generally comprise a porous ceramic filter that filters most microorganisms larger than about 0.5 μm in diameter out of the water. Chemical disinfectants such as chlorine and iodine tablets or chlorine bleach are also used for the microbiological purification of the water, sometimes in combination with chemical flocculation for decreasing the water turbidity. However, all of these methods suffer from one or more serious disadvantages. Solar disinfection is certainly low-cost but is also a very slow water purification process that is dependent on the presence of sunlight. Chemical flocculants/disinfectants are often not readily available in many local communities in Third-World countries and furthermore suffer from a relatively high cost price. In addition, they impart a taste to the drinking water that is perceived as unpleasant by most consumers. The use of a porous ceramic filter in a gravity-fed water purifying device suffers from a slow purified water production rate when a modestly-sized ceramic filter is involved, and is furthermore plagued by filter clogging problems caused by deposited particulate material that can quickly obstruct the water passage through the filter pores. This can be avoided by increasing the porosity/permeability of the filter but this immediately leads to a less efficient filtration process, and as a consequence a less efficient purification of the water from microbiological organisms. Another way of solving this problem is by significantly increasing the size of the ceramic filter (and thus also the size of the water purifier) but this will raise the costs (which is not desirable in Third-World countries) and is often not practical. In an effort to increase the water filtration speed through small-sized ceramic filters, use has been made of an air-pressure driven filtration process instead of a gravity-driven filtration process, however this requires the presence of an additional manual air pump and imposes high (and thus costly) demands on the sealing of the pressurized compartment of the water purifier. Bio-sand filters can be very effective in removing a variety of contaminants from water, but suffer from a number of disadvantages associated with their generally large size, their lack of portability, the required skill to construct a bio-sand filter, the requirement that they have to be operated in a more-or-less continuous manner in order to maintain their effectivity, and their strict maintenance requirements.

The object of the invention is to provide a manually operable water-purifying device, which provides a solution for the above-identified problems.

This object is achieved by the invention by providing a manually operable device for purifying water, comprising a water container for receiving and holding an amount of non-purified water, comprising a bottom and side walls and adapted to receive a manually operable piston-type filter assembly, said filter assembly comprising filtering means for filtering said non-purified water, wherein said filter assembly is adapted to be manually forced towards the bottom of the said container, thereby allowing said non-purified water to pass through the said filtering means thereby purifying the waterWith the device according to the invention a low-cost water purifier is provided which can be used to provide an improved drinking water quality under primitive (outdoor) conditions, wherein no water pressure and/or electricity is present.

The water-purifying device of the invention thus comprises two main parts:
(1) a water container for receiving and holding a limited volume of non-purified water; and
(2) a piston-type filter assembly, comprising a porous water filter, designed such that it can be tightly received by the water container and pushed or screwed into the container by manual force down towards the bottom of the container, thereby forcing the water from the container to pass through the porous water filter, such that the water is cleaned from at least some of various water pollutants, including microbiological species, particles, cysts, turbidity, organic compounds, volatile organic compounds (VOCs), chlorine, heavy metals, etc.

The non-purified water in the container is simply purified and subsequently transferred by exerting a force on the piston-type filter assembly, serving to push the filtering means into the container and allowing the non-purified water to pass through the filtering means thereby filtering the water. The filtered and purified water can then be received in a reservoir. It is noted that this water can also be transported from the outlet of the filter assembly directly to the outside of the device, via for example a tube or the like, without being received in a reservoir. The force on the piston-like filter assembly can e.g. be exerted manually or via a separate weight placed on top of the piston-type filter assembly, thereby creating a pressure-differential across the water filtering means, the said pressure-differential being the driving force for the water filtration process.

In a preferred embodiment of the invention, the filter assembly of the water-purifying device of the invention comprises a valve for providing a one-way direction of the water flow through the said filtering means from the container, serving to only allow non-purified water to flow from the container, and preventing purified water to flow back into the container.

In another preferred embodiment of the invention, the purified water is to be received in a reservoir for receiving filtered purified water, and said valve for providing a one-way direction of the water flow through the said filtering means from the container into the reservoir is provided between the said filtering means and the said reservoir.

According to a further preferred embodiment of the invention, the filter assembly comprises throttle means for limiting the filtration speed of the water to below a set maximum filtration speed. In order to attain reliable purification of the water it is important that the filtration speed of the water through the filtering means does not exceed a certain maximum, thus allowing a sufficient contact time between the water and the filtering means.

In a particularly preferred embodiment of the device according to the invention, the said valve provided in the said filter assembly is a ball-valve, comprising a ball having a density higher than 1 gram/cm³. The ball will close the valve, thereby preventing water flow, in a situation wherein an attempt is made to reverse the water flow through the filtering means from the reservoir back into the container. An additional advantage of this embodiment is that the ball-valve can also be used to limit the water flow through the ball-valve up to a set maximum value. In this way, the valve for providing a one-way direction of the water flow through the filtering means from the container into the reservoir thus also serves as a throttle means for limiting the filtration speed.

The device according to the invention may comprise any known (combination of) filtering means. Preferably, the filtering means comprise at least one porous particle filter for filtering particles and microbiological organisms from the non-purified water. The porous particle filter may be complemented with at least one absorption and/or adsorption medium filter for removing e.g. chlorine, heavy metals, arsenic, fluoride, VOCs, pesticides etc. from the water. The adsorption/absorption medium may be present within the said porous particle filter or may be present as a separate filter or inside a separate filter.

In a preferred embodiment of the present invention, said porous particle filter is a porous ceramic filter. The advantage of using a ceramic filter is that it can be easily cleaned from deposited particulate material with e.g. a scrubber, thereby avoiding a quick clogging of the porous particle filter with particulate material and thus improving the filter lifetime. Preferably, the said porous ceramic filter is impregnated with a bacteriostatic compound, such as silver or copper, in order to prevent the growth of microorganisms on and inside the said porous ceramic filter.

In a further embodiment of the present invention, said porous ceramic filter comprises an abradable porous ceramic filtration material. The advantage of using a an abradable porous ceramic filtration material is that it can be easily cleaned from deposited particulate material with abrasive techniques, thereby removing deposits and creating a new and clean filter surface. This also avoids a quick clogging of the porous particle filter with particulate material and thus improves the filter lifetime. In a further embodiment of the present invention, said filtering means comprise a ceramic non-textured filtration surface on a side of said filtering means facing said non-purified water. This further enhances the cleanability by hand of the filtering means.

In a particularly preferred embodiment of the present invention, the filtering means comprise a first porous particle filter, a second adsorption/absorption media filter and a third porous particle filter. The first particle filter preferably is a compressed porous ceramic filter, for filtering (microbiological) particulates, bacteria and cysts from the water. The second adsorption/absorption medium filter may e.g. contain granular activated carbon or a compacted activated carbon filter block, possibly in combination with other types of well-known adsorption/absorption media for removing e.g. arsenic, fluoride and heavy metals such as lead and mercury from contaminated water. The third porous particle filter provides a final filtration to the water and avoids adsorption/absorption media particles derived from the adsorption/absorption filter to become suspended in the final filtered water.

In a further preferred embodiment of the present invention, the water container of the water-purifying device of the invention is provided with at least one hole in a side wall for setting the upper filling level of said container. Excess water will thus leak away through the hole. In addition, the hole serves to allow air escape from the container when the piston-type filter assembly is lowered from the top of the container downwards into the container.

Preferably, the water container is further provided with a sealable aperture in or near the bottom of the container for receiving and/or draining non-purified water into or from said container. This way, any remaining non-purified water can be drained from the container. In addition, non-purified water can be fed into the container from e.g. a larger vessel through said aperture.

In a further particularly preferred embodiment of the invention, the outer sides of the container and /or the filter assembly have a dark color. This allows the container and/or the filter assembly and the (remaining) water inside the water-purifying device to become disinfected through heating by exposing the device to sunlight for a certain period of time, thus heating the container and/or the filter assembly and the water remaining therein.

In yet another preferred embodiment, the container of the water-purifying device of the invention is provided with a one-way valve near the bottom of the said container allowing water to enter the said container through said one-way valve while prohibiting water escape from the said container through said one-way valve. The said one-way valve thus allows a substantially unhindered passage of water to flow from e.g. a storage vessel for contaminated water via the said one-way valve into the said container under the driving force of a pressure-differential that is created when the filter assembly is retracted from the said container, while blocking the passage of water out of the said container through the said one-way valve when the said filter assembly is lowered into the said container.

In another preferred embodiment, the reservoir associated with the piston-type filter assembly of the water-purifying device of the invention is provided with a protruding spout near the top of the said reservoir, said spout serving to facilitate a substantially unhindered flow of filtered water from the said reservoir into a separate purified-water vessel during the water filtration process when the said piston-type filter assembly is lowered into the container. Thus the necessity of tilting the entire water-purifying device when the filtered water is to be poured out of the reservoir is avoided.

In yet another particularly preferred embodiment, the water-purifying device of the invention is provided with a lever construction, said lever construction serving to exert an amplified force onto the piston-type filter assembly of the said water-purifying device. This torque-enhanced force facilitates a quick lowering or rise of the filter assembly into or from the contaminated water-filled container at the expense of a relatively modest human effort, thereby increasing the water filtration rate through the water filtering means associated with the filter assembly and enhancing the user-friendliness of the water-purifying device.

The present invention is further illustrated in the following figures.

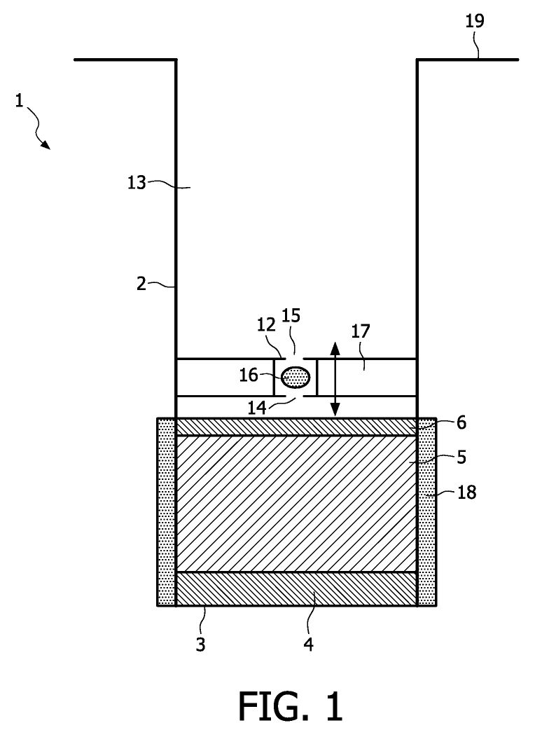

FIG. 1 schematically shows an embodiment of a piston-type filter assembly to be used in the device of the invention, comprising a one-way ball-valve between the filtering means and the reservoir.

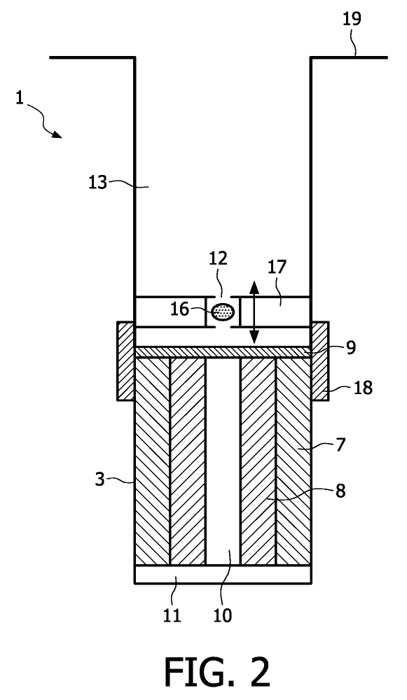

FIG. 2 shows another embodiment of said filter assembly, comprising another configuration of the filtering means.

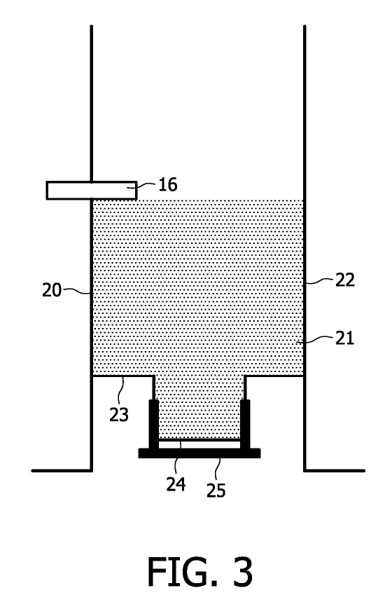

FIG. 3 schematically shows a water container of the water-purifying device of the invention.

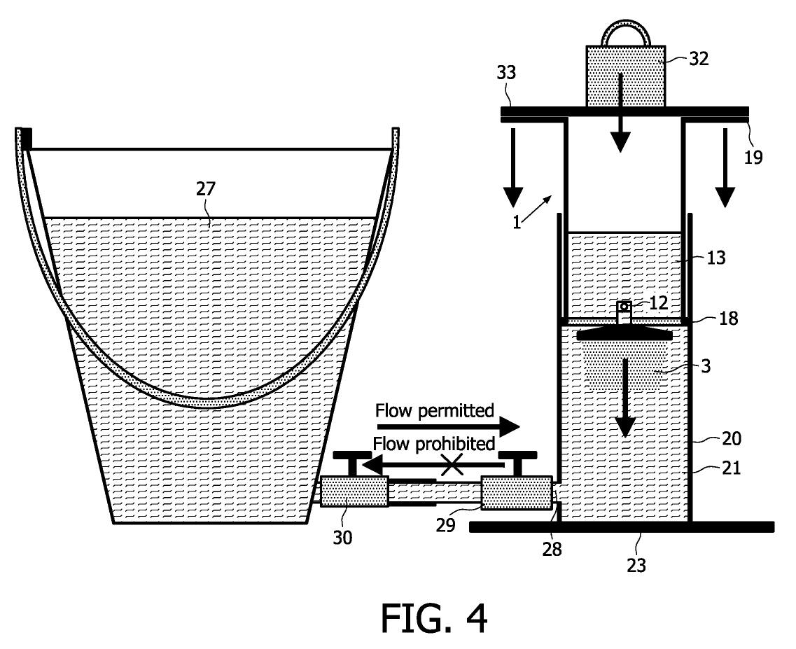

FIG. 4 shown an embodiment of the water-purifying device of the invention wherein both the water container and the piston-type filter assembly are shown, in combination with a separate vessel for contaminated, i.e. non-purified water to be fed into the container.

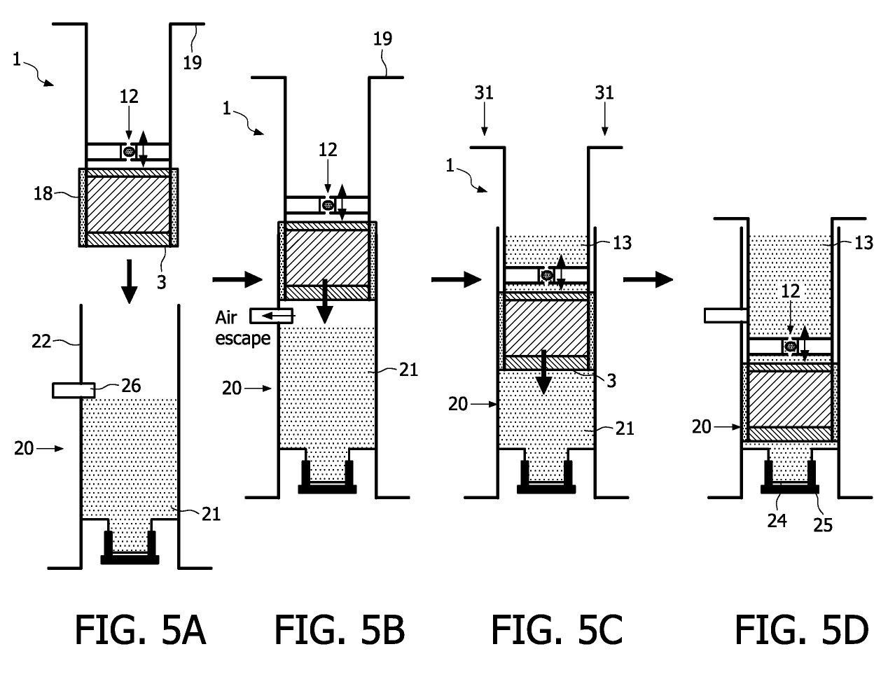

FIG. 5 shows, in steps, the method for purifying water using the water-purifying device of the invention.

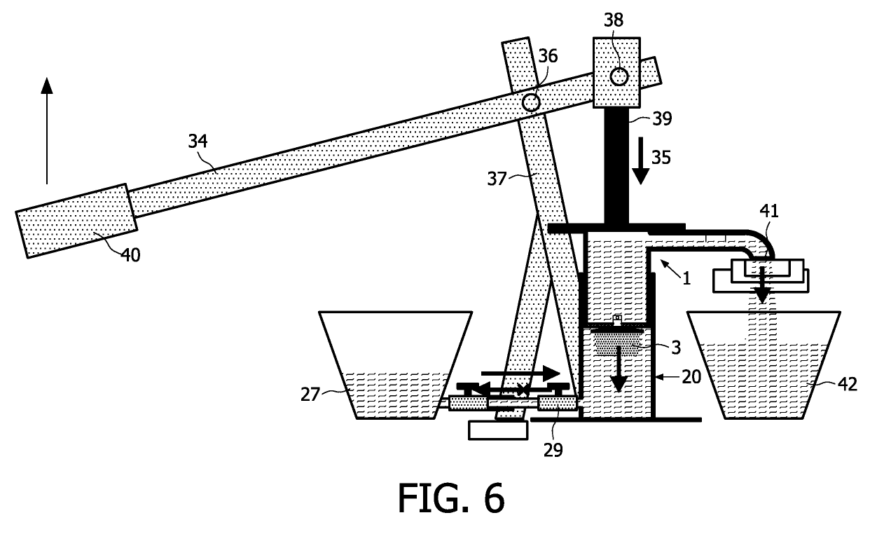

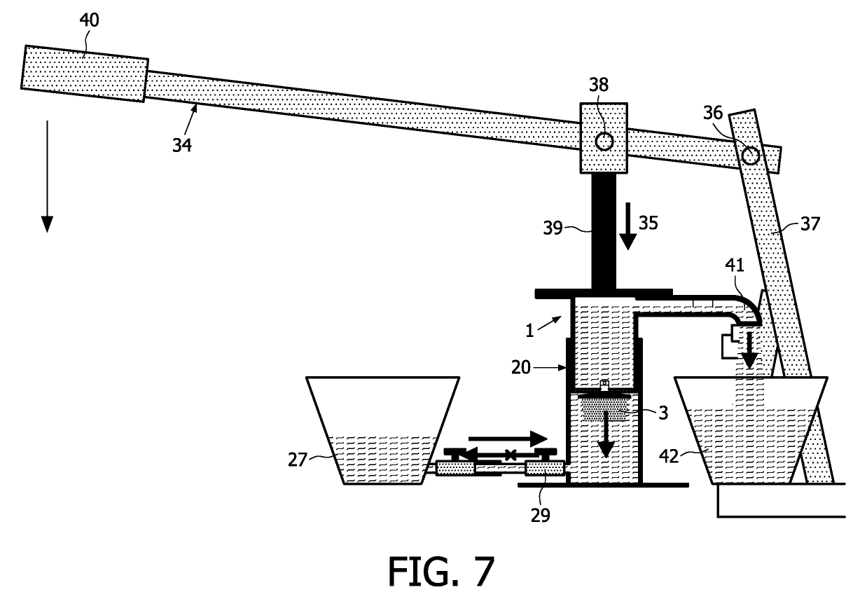

FIGS. 6 and 7 show different embodiments of the water-purifying device of the invention provided with a lever construction, the lever serving to exert an amplified force onto the piston-type filter assembly which can be used to either lower the filter assembly down into the container or to retract the filter assembly upward out of the container. The water-purifying device is furthermore provided with a vessel from which non-purified water can be fed into the container, and is provided with another vessel that serves to receive filtered water via a spout from the reservoir of the water-purifying device.

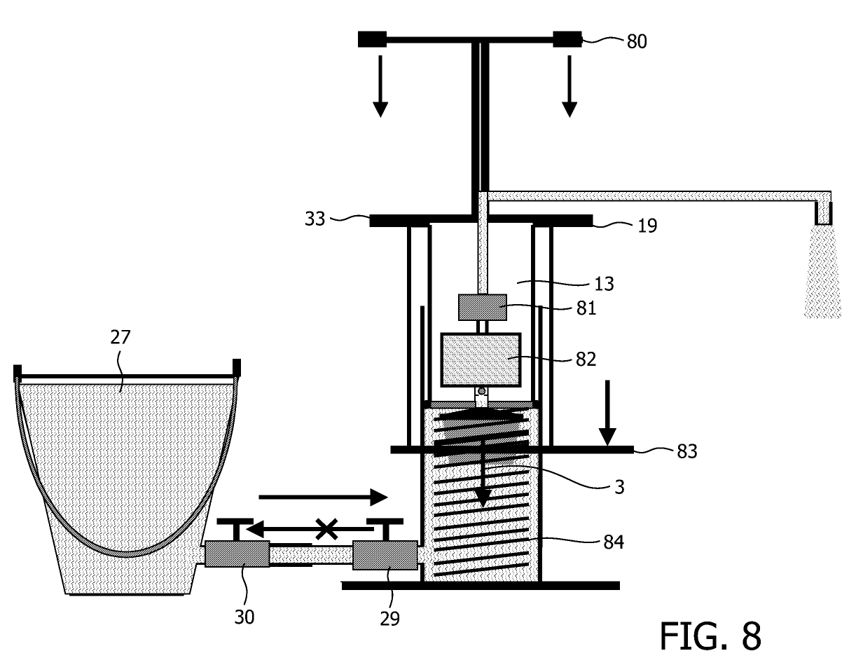

FIG. 8 shows an alternative embodiment of the manual water-purifying device according to the invention.

As shown in FIG. 1, the piston-type filter 1 assembly comprises a cylindrical holder 2 provided with flat water filtering means 3 at its bottom. The water filtering means 3 comprise a first bottom porous particle filter 4, e.g. a compressed porous ceramic filter, for filtering microorganisms, particles and e.g. cysts from contaminated water. This filter may be manually cleaned, e.g. with a scrubber, from deposits or, alternatively, be replaced by a new filter, if necessary.

It is observed, that said porous ceramic filter may comprises an abradable porous ceramic filtration material. The advantage of using a an abradable porous ceramic filtration material is that it can be easily cleaned from deposited particulate material with abrasive techniques, thereby removing deposits and creating a new and clean filter surface. This also avoids a quick clogging of the porous particle filter with particulate material and thus improves the filter lifetime. Furthermore, said filtering means may comprise a ceramic non-textured filtration surface on a side of said filtering means facing said non-purified water. This further enhances the cleanability by hand of the filtering means. The water filtering means 3 further comprise an adsorption/absorption medium filter 5, e.g. containing granular activated carbon, or a compacted activated carbon block, for removing chlorine, VOCs, THMs, lead, mercury, pesticides etc from the water thus improving its taste and smell. A third top porous particle filter 6 is present for providing a final filtration to the water and preventing particles from the adsorption/absorption medium to become suspended in the purified water.

In FIG. 2 another possible configuration of the filtering means 3 of the invention is shown. Thus, cylindrical water filtering means 3 are shown instead of a flat water filtering means, comprising an outer cylindrical particle filter 7, an inner cylindrical adsorption filter 8 (e.g. carbon block filter) and a top porous particle filter 9. Water that has passed through particle filter 7 and adsorption filter 8 flows through the inner passage 10 for filtered water to and through the top porous particle filter 9. A bottom covering cap 11 is provided in order to ensure that the non-purified water flows through all filter components of the cylindrical water filtering means 3 into the reservoir 13 for filtered purified water. Cylindrical filtering means provide extra filtration area and thus may allow for a comparatively higher water filtration rate at a given pressure-differential across the filtering means. The filtering means 3 may be either clamped or glued into the bottom of the reservoir 13, or may be screwed as a removable filtering unit into a separate reservoir bottom plate.

The filter assembly 1 is provided with a reservoir 13 for filtered water. It is noted that, in stead of being received in a reservoir, in another embodiment the purified water can also be transported from the outlet of the filter assembly directly to the outside of the device, via for example a tube or the like, without being received in a reservoir. In this embodiment, in addition, the piston-type filter assembly, as shown in both FIG. 1 and FIG. 2, is provided with a ball-valve 12 serving to provide a one-way direction of the water flow through the filtering means 3. The ball-valve 12 is provided between the filtering means 3 and the reservoir 13 for receiving purified water and is supported by supporting means 17. The ball-valve 12 has an inlet 14 and an outlet 15 and comprises a moveable ball 16 having a density higher than 1 gram/cm3. Ball 16 will close inlet 14 of the valve 12 in a situation of no water flow, or when an attempt is made to reverse the flow through the filtering means from the reservoir back into the container. This will stop any downward water flow through the filter. In addition, the ball-valve will limit the filtration speed through the filtering means 3, i.e. when the water flow is too high, the ball 16 in the ball-valve 12 will close outlet 15 of the valve, thus effectively limiting the water flow through the valve to a set maximum value. In this way, the means for providing a one-way direction of the water flow through the filtering means simultaneously serve as throttle means for limiting the water filtration speed. A limiting of the water flow through the filtering means to below a set maximum flow is particularly important when the filtering means comprises an adsorption or absorption medium. A sufficiently long contact time of the contaminated water with the adsorption or absorption medium is required for guaranteeing a prescribed degree of concentration reduction of a waterborne contaminant that is to be adsorbed or absorbed, respectively, by the medium.

The filter assembly of the invention is further provided with an outer elastic medium or element, such as a deformable O-ring 18, serving to provide a mating fit of the piston-type filter assembly with the container, thus allowing the filter assembly to be tightly received by the container during water filtration, and substantially avoiding water leakage at the contact area between the filter assembly and the container (as shown in FIGS. 1, 2 and 4). It should be noted though that even if some leakage of contaminated water from the container would occur at the said contact area, this would by itself not lead to any intrusion of non-filtered water into the reservoir of the filter assembly, containing the purified water.

As shown in FIGS. 1 and 2 the filter assembly 1 further comprises a handling flange 19 at the top of the reservoir 13 for operating the water-purifying device according to the invention. The handling flange may be covered with a lid in order to shield the interior of the reservoir 13, thereby preventing a possible re-contamination of the filtered water in the reservoir 13 e.g. by airborne contaminants.

FIG. 3 schematically shows an embodiment of a vertically positioned water container 20 provided with an open top, comprising side wall 22 and a bottom 23, comprising non-purified water 21. The bottom 23 is provided with an aperture 24 that is sealable with a screw-cap 25 to allow drainage of non-purified water from the container 20, and a small hole 26 in the side wall 22 serving to set the upper filling level of the container. Thus, any excess of water will leak away through the hole 26.

FIG. 4 shows another preferred embodiment of the water-purifying device of the invention, in combination with a large vessel 27 for non-purified water, which is fed into the container through aperture 28. Feeding of the non-purified water from the large vessel 27 into the container is controlled by one or more valves 29, 30. Preferably, the valve 29 directly adjacent to aperture 28 is a one-way valve that allows a substantially unhindered passage of water through the aperture 28 into the container 20 but prevents an escape of water from the container through the aperture 28. Preferably, the valve 30 directly adjacent to the large reservoir 27 is a valve that can be manually opened or closed. Instead of feeding contaminated water from a large vessel 27 into the container 20 via the aperture 28, the contaminated water can also be directly drawn via the aperture 28 into the container 20 as surface water from e.g. a river or lake.

A method for purifying water using the water-purifying device described above is set out in FIG. 5. Thus, as shown in step A of FIG. 5, non-purified, i.e. non-potable water 21 is held in container 20. The hole 26 in side wall 22 serves to set the upper filling level of the container 20, and additionally serves to allow air escape when the filter assembly 1 is lowered into the container 20 up until the moment when the filtering means touch the surface of the contaminated water 21 in the container, as shown in step B. As shown in step C, for purifying the water a force 31 is to be exerted onto the handling means 19 of filter assembly 1 to push the filter assembly 1 further downwards into the container 20, thereby allowing the non-purified water 21 from said container to flow through the filtering means 3, thus purifying the water. The force 31 sets-up a pressure-differential across the filtering means 3, said pressure differential becoming the driving force for water flow from the container 20 through the filtering means 3 into the reservoir 13. At a given strength of the force 31, the pressure differential can be increased by decreasing the diameter of the piston-type filter assembly 1. The force 31 can be applied by a simple manual pushing onto the handling flange 19, or, for example, via gravity, as shown in FIG. 4, by placing an heavy item 32 (e.g. a piece of rock or a weight) onto a covering lid 33 that is positioned on top of the handling flange 19 of the filter assembly 1. A gravity-driven force 31 can also be attained by allowing a person to sit on the covering lid 33, as shown in FIG. 4, thus using the weight of a human body for the weight 32. The filtered clean water is received by reservoir 13 and can be simply poured out of the reservoir after the filtration process is completed, i.e. after the filter assembly 1 has been pushed towards the bottom of the container 20 (step D of FIG. 5). In order to withdraw the filter assembly from the container, the screw cap 25 in FIG. 5 can be released thus draining any remainder of the non-purified water through aperture 24 and allowing air to simultaneously enter into the container 20 through aperture 24, thereby facilitating an easy withdrawal of the entire filter assembly 1 from the container 20. While withdrawing the filter assembly 1 from the container 20, the clean purified water stays inside the reservoir 13 from where it can e.g. be poured into a cup for human consumption.

As shown in FIG. 4, the top of the reservoir 13 associated with the filter assembly 1 of the water-purifying device of the invention, is provided with a flange 19 and a removable lid 33 on top of the said flange. The flange 19 preferably is provided with a cross-section that is substantially wider than the cross-section of the said reservoir 13, thus allowing a (large) weight 32 to be placed on top of (the lid 33 on) the flange 19, thus facilitating the creation of a (significant) force 31 with which the filter assembly 1 can be lowered into the contaminated water-filled container 20. This force establishes a significant pressure differential across the filtering means 3 when the reservoir 13 of the filter assembly 1 is provided with a relatively small diameter, thereby increasing the water flow through the filtering means 3. Instead of placing a weight 32 on top of the lid 33, one can also choose to sit on the lid when the lid is provided as a substantially horizontal platform, thereby using the weight of a human body for creating the pressure-differential across the water filtering means 3 between the container 20 and the reservoir 13.

FIG. 8 shows an alternative embodiment, in which the top of the reservoir 13 associated with the filter assembly 1 of the water-purifying device of the invention is provided with a flange 19 and a removable lid 33 on top of the said flange, and said lid is provided with a handling bar 80. The use of this handling bar eases the manual pumping action because users do not have to bend down any longer in order to grab the top of the filter assembly. Furthermore, a helical spring 84 inside the reservoir 13 serves to increase the ease with which the piston-type filter assembly can be raised inside the water container. When the piston-type filter assembly is lowered towards the bottom of the water container, the helical spring is compressed. When the filter assembly is raised from the bottom of the water container, the relaxing spring much reduces the pulling force required to raise the filter assembly. To further enhance the force with which the filter assembly can be lowered into the reservoir, a platform 83 is suspended from the top of the filter assembly, the platform being shaped such that it fits around the water container, thus helping to guide the up/down motion of the filter assembly. The force increase is accomplished by allowing one's foot to rest on this platform when the filter assembly is lowered, the force resulting from the weight of the foot and the leg associated with this foot. Instead of allowing only one foot/leg to rest on this platform, one can also simply step onto this platform and use one's entire body weight to even further increase the force with which the filter assembly is lowered into the water container. Also a further water filter 82 may be comprised in the filter assembly, to further increase the level of purification of the water. Furthermore, an electrical pump 81 may be comprised in the filter assembly. In some countries electricity may be available for a number of hours per day. In case electrical power is present, one can simply engage the electrical pump to pull the water through the water filters inside the filter assembly without having to perform any manual pumping effort. It is advantageous, when the electrical pump is positioned downstream of the water filter, to avoid that the electrical pump comes into contact with contaminated water; this highly increases the operational lifetime of the pump.

The outer sides of the filter assembly 1 and/or the container 20 preferably have a dark color to allow a quick heating of the water purifying device and the water therein by exposing the water-purifying device to direct sunlight. Such heating can by itself be sufficient for water disinfection with respect to viruses and bacteria, provided that the temperature exceeds 70-80° C. for at least 30 minutes. Thus, the device may be particularly useful in many Third World countries where abundant sunlight is readily available for a considerable period of time throughout the year. Alternatively, or additionally, the contaminated water may also be first chemically disinfected inside the container 20 and/or inside the vessel 27 (in FIG. 4) by adding e.g. chlorine or iodine tablets to the contaminated water and leaving the chlorine or iodine in contact with the water for at least 30 minutes to allow all bacteria and viruses to be killed. Subsequently, the disinfected water can be filtered by the water-purifying device according to the invention, in order to remove additional water-borne contaminants and, for instance, to ensure the removal of an unpleasant taste and/or smell from the water that originates from the initial chemical water disinfection. Water storage for some time inside the container 20 or inside the vessel 27 (in FIG. 4) may also be useful for allowing sedimentation of suspended coarse particles from the water.

FIGS. 6 and 7 show alternative embodiments of the manual water-purifying device according to the invention with which a large purified water production rate can be accomplished at the expense of only a modest human effort. To this end, the water-purifying device is provided with a lever 34 with which an amplified force 35 can be applied onto the filter assembly 1. For this purpose, the lever 34 is connected at one end via pivot 36 to a rigid lever support structure 37 and connected via another pivot 38 to a connecting bar 39 that contacts the filter assembly 1. As shown in FIG. 6, by manually raising or lowering the opposite end of the lever (i.e. the lever-handle 40), the filter assembly 1 is lowered into and retracted from the container 20, respectively, at the expense of only a modest manual effort due to the creation of a torque-enhanced force on the filter assembly 1. In FIG. 7, the manual raising or lowering of the lever-handle 40 causes the filter assembly 1 to become retracted from and lowered into the container 20, respectively. In addition, the filter assembly 1 in FIGS. 6 and 7 has been provided with a spout near the top of the reservoir 13 via which purified water from the reservoir 13 can be readily transferred via gravity into a separate purified-water vessel 42 without requiring a manual handling of the water-purifying device. A separate contaminated-water storage vessel 27 has been connected via a one-way valve 29 to the container 20 of the water-purifying device, the one-way valve 29 only allowing a one-way transfer of contaminated water from the storage vessel 27 into the container 20 when a pressure-differential is created between the container 20 and the contaminated-water storage vessel 27 during the retraction of the filter 1 assembly from the container 20. As such, a reciprocating upward—downward movement of the lever-handle 40 effectively induces a pumping action with which water is drawn in strokes from the contaminated-water storage vessel 27 via the container 20 and filtering means 3 into the reservoir 13 of the water-purifying device from where it is discharged via the spout 41 into the separate purified-water vessel 42. In this way a large purified water production rate can be accomplished with a small-sized water-purifying device at the expense of only a modest manual effort. By fully withdrawing the filter assembly 1 from the container 20, the then exposed porous particle filter in FIGS. 6 and 7 can be manually cleaned from deposited particulate material.

1. Manually operable device for purifying water, comprising a water container for receiving and holding an amount of non-purified water, comprising a bottom and side walls and adapted to receive a manually operable piston-type filter assembly said filter assembly comprising filtering means for filtering said non-purified water, wherein said filter assembly is adapted to be manually forced towards the bottom of the said container, thereby allowing non-purified water to pass through the said filtering means thereby purifying the water.

2. Device according to claim 1, wherein said filter assembly comprises a valve for providing a one-way direction of the water flow through the said filtering means.

3. Device according to claim 2, wherein the said purified water is to be received in a reservoir for receiving filtered purified water, and said valve is provided between said filtering means and said reservoir.

4. Device according to claim 1, wherein said filter assembly comprises throttle means for limiting the filtration speed of the water.

5. Device according to claim 2, wherein said valve (12) is a ball-valve, comprising a ball having a density higher than 1 gram/cm³.

6. Device according to claim 1, wherein said filtering means comprise at least one porous particle filter.

7. Device according to claim 6, wherein said porous particle filter is a porous ceramic filter.

8. Device according to claim 7, wherein said porous ceramic filter comprises
an abradable porous ceramic filtration material.

9. Device according to claim 1, wherein said filtering means comprise a ceramic non-textured filtration surface on a side of said filtering means facing said non-purified water.

10. Device according to claim 1, wherein said filtering means (3) comprise a first porous particle filter, a second adsorption/absorption medium filter and a third porous particle filter.

11. Device according to claim 1, wherein said container is provided with at least one hole in a side wall for setting the upper filling level of said container.

12. Device according to claim 1, wherein said container is provided with a sealable aperture in or near the bottom of said container for receiving and/or draining non-purified water into or from said container.

13. Device according to claim 1, wherein the outer side of said container and/or said filter assembly have a dark color.

14. Device according to claim 1, wherein said container is provided with a one-way valve near the bottom of said container, allowing water to be fed into the container while prohibiting water escape from said container.

15. Device according to claim 1, wherein said reservoir associated with said piston-type filter assembly is provided with a spout for drainage of the purified water from said reservoir.

16. Device according to claim 1, wherein said device is provided with a lever, said lever serving to exert an amplified force with onto said piston-type filter assembly.
